(19) United States
(12) Patent Application Publication
(10) Pub. No.: US 2002/0052801 A1
(43) Pub. Date: May 2, 2002

(54) Hosted asset procurement system and method

(76) Inventors: Phillip G. Norton, McLean, VA (US); Mindy I. Barton, Manassas, VA (US)

Correspondence Address: Stevens, Davis, Miller & Mosher, L.L.P., Suite 850, 1615 L Street, N.W., Washington, DC, 20036, US

(21) Appl. No.: 09/984,861

(22) Filed: Oct. 31, 2001

Related U.S. Application Data
(60) Provisional application No. 60/244,915, filed on Nov. 2, 2000.

(51) Int. Cl. G06F 17/60

(52) U.S. Cl. 705/26

(57) ABSTRACT

A hosted system and method for at least one procuring organization to electronically order assets from at least one seller's electronic catalog is provided in which the host participates as a seller of assets and provides a full electronic catalog of products. A procuring organization is assigned at least the host's electronic catalog but may be assigned any number of seller catalogs, including custom catalogs in which assets are offered to the procuring organization at predetermined prices. A procuring organization can specify approval workflow routes in the procuring organization which electronic orders must successfully traverse before being sent, electronically, to sellers.

### CROSS REFERENCE TO RELATED APPLICATION

This is a non-provisional application claiming the benefit of provisional application number 60/244,915 filed on Nov. 2, 2000, the entire disclosure of which is hereby incorporated by reference.

### BACKGROUND OF THE INVENTION

1. Field of the Invention

The present invention relates to the field of asset management for supply chains of partner organizations. In such a supply chain, as the individual partners procure assets and asset-related services from one another, these assets are both used and transformed into other assets which may travel further in the supply chain. Information about these assets and asset-related services can be captured in a data store and managed by an asset management system to both facilitate, e.g., by providing catalogs, and documenting individual asset-related transactions between partners. Asset information in such a data store replaces physical inventory as the means of most competitively satisfying customer demand.

More particularly, the present invention is directed to an independent Internet accessible web-based system and method for a hosted system that is employed by partner organizations in a supply chain to procure assets and asset-related services from other partners.

2. Discussion of the Prior Art

Supply chain systems and asset procurement systems are known in the art. These known systems employ a range of architectures, such as inventory pipeline management systems tightly coupled to dedicated database systems and catalogs, to loosely coupled systems interfaced with federated independent database systems and independent catalogs. But, regardless of the architecture of these systems, the asset procurement functions of these existing supply chain systems are tightly coupled to other functions, such as information management, sales, and accounting. The focus of these existing systems has been the physical inventory of assets and information which reflects the characteristics of this physical inventory, including product catalogs.

Taking an independent view of the functionality needed by supply chain systems for procuring assets, such systems must have access to a broad spectrum of supply chain asset information to enable partner organizations to procure assets for their own businesses and similarly to supply assets to other partners. Asset information needed to support procurement includes catalogs of assets which are being offered by one set of partners to be procured by other partners, asset availability, asset options, etc.

Asset systems have historically been directed to capturing and reporting information about such activities as procurement, installation, leases, status, etc., with respect to the inventory of an organization's assets. Usually, paper and electronic catalogs support these systems.

Modern procurement systems involve pre-negotiated prices specific to the procuring organization, i.e., a custom catalog is needed for each procuring entity, on-the-spot entered items are required to accommodate the rapid pace at which new products come to market, and tailored procurement approval processes (workflows) are needed to match each organization's procurement approval process. Repeat purchasers want to have a standing order or template for the configured products they regularly order, and purchase status information is needed on demand and quickly for review.

Most partners in supply chains have functionally-oriented legacy systems for managing their businesses, which include managing inventory and capital assets. Few have historically provided external partners access to these internal systems and their information stores. This is true for independent businesses participating in a supply chain and it is just as true for vertically integrated businesses where different departments and divisions function in much the same manner as independent businesses, due to their cost center orientation.

These functionally specific internal legacy systems have evolved either loosely or tightly coupled procurement components, usually the latter. The architecture of such legacy procurement components varies from one system to the next but is ill-suited to electronic linking over the Internet, a requirement resulting from more and more demand being placed on participants to provide their partners in chains of suppliers with online access to their procurement and production data. Access to procurement and production data is needed by partners to enhance each partner's management of its business, e.g., to support contract, payable, and order management by each partner. For example, a partner who supplies raw materials has an aged inventory of such materials over time derived from purchases of raw materials from sources in anticipation of demand from partners and accounts payable resulting from these purchases; contracts with both sources and supply chain partners, and orders resulting from these contracts; etc. Access to partner information is needed by such a supply chain partner to manage contracts, orders, and payables and as well as to verify orders, i.e., to perform procurement and procurement related functions most efficiently and effectively.

Externally, procurement management is expanding to include information about supply chain partner' businesses and has grown in importance as more of each partner's success depends on this procurement-related information, so much so, that functions such as catalogs and procurement approval processes (workflows) are now routinely made available to partners. The chain of suppliers involved in producing, procuring, financing, delivering and maintaining assets, i.e., the external extended enterprise, and the supply chain itself are now the focal points of expanded asset management systems in which information has replaced inventory. Predictably, functionally oriented legacy procurement systems cannot easily be changed to reflect this reordering of importance of functions or the shift to an external extended enterprise focus for the supply chain process. And in fact, existing internal systems have not accommodated this shift in focus. Internal legacy procurement systems and their information are almost never available to other supply chain partners because they include information that an organization does not want to share or make public; these systems were never intended to be externally accessible and are not sufficiently robust; and, retrofitting such systems is either not economically attractive or not technically feasible, or both.

The extended enterprise exists by virtue of the Internet. The Internet has enabled business-to-business interaction and formation of relationships to take place at unprecedented speed and with incredible visibility. Maintaining this form of business interaction requires an ever-increasing and unprecedented level of procurement information, function, and approval process (workflow) intimacy which most individual businesses are ill-prepared to undertake on their own.

Thus, there is a need for a reliable Internet-accessible system and a method to support procurement of assets across organizations and well as within them, a system and method which emphasize the asset information intensity and extended enterprise characteristics of Internet-based supply chains which extend across multiple enterprises and which intersect.

### SUMMARY OF THE INVENTION

The system and method according to the present invention are a hosted response to the need for an Internet-accessible web-based procurement management system identified above. This hosted system is meant to be both a standalone procurement system, illustrated in FIG. 1a, as well as a component of a total asset management system, illustrated in FIG. 1b, a component that provides the procurement information, function, and process (workflow) dimensions for supply chain partners to manage the procurement-related aspects of their businesses by leveraging their supply chain participation.

The hosted procurement system and method of the present invention are functionally and informationally architected to be open. As supply chain partners gain experience and grow comfortable with procurement information, function and approval process (workflow) accessability, the system and method of the current invention are architected so as to be able to expand to encompass more and more data, functions, and workflow processes once held exclusively within the confines of each partner's organization, e.g., contract terms, and price controls.

The hosted procurement system and method of the present invention automate a partner organization's procurement process and provide a range of procurement support functions including a variety of online catalogs, including customizable catalogs, automated ordering and approval processes (workflows), electronic submission of orders to vendors, tracking of orders, etc., needed by supply chain partners to manage their procurement activities in a supply chain. Such information is created, stored, accessed and updated in a standard way regardless of the source or user of the information. In the hosted approach of the present invention, not only are procurement functions standardized but uniform data storage and access techniques are imposed, so that integrity, reliability and accessibility are also inherent in the system and method according to the present invention.

In addition to procurement functions, catalogs, approval processes or workflows, and databases, a preferred embodiment of the present invention provides a range of procurement reports which can be viewed, printed and downloaded either in report format or a format suitable for input to legacy systems (manual or automated).

These report and download features include, among others, purchase order and requisition information which are selected and customized from a web-page interface.

The present invention enables supply chain partners (which includes customers) to leverage information about their and their partners procurement practices, products and services, and assets by, among others:

Converting existing procurement practices to Internet processes;

Replacing inventory with information;

Creating a standardized, reliable, accessible repository of procurement information, such as catalogs, across the extended enterprise;

Providing many partners with access to procurement management functionality not previously available to them due to resource constraints;

Guaranteeing the integrity of the procurement processes and data;

Delivering business intelligence in a format that can be interfaced with legacy systems; and

Reducing administrative costs.

All of these effects create immediate cost savings and result in long-term efficiencies.

### BRIEF DESCRIPTION OF THE DRAWINGS

A more complete understanding of these advantages and other advantages of the present invention may be acquired by referring to the following description taken in conjunction with the accompanying drawings, in which like reference numbers indicate like features and wherein:

FIG. 1a is a block diagram of a preferred embodiment of a hosted procurement system according to the present invention as a standalone system.

FIG. 1b is a block diagram of a procurement management system which interfaces with a hosted asset management system, including the procurement system according to a preferred embodiment of the present invention illustrated in FIG. 1a.

FIG. 1c is a block diagram of the procurement process flow according to the present invention.

FIG. 2a is an exemplary database schema for shoppers, cost centers, departments, roles, and permissions.

FIG. 2b is an exemplary database schema for orders that relates order line items to cost centers.

FIGS. 2c-d are an exemplary database schema for purchase approval processes or workflows and for actual approval routes being traversed by active orders.

FIG. 3 is an exemplary home web-page of the hosted Internet accessible web-based procurement system.

FIG. 3 is an exemplary main menu screen.

FIG. 4 is an exemplary Catalogs Menu screen.

FIG. 5 is an exemplary Blank Worksheet screen.

FIGS. 6a-e are an exemplary database schema for sellers and catalogs of products offered for sale.

FIG. 7 is an exemplary Product Search screen.

FIG. 8 is an exemplary Product List screen.

FIG. 9 is an exemplary Category Menu of the Standard Products Catalog.

FIG. 10 is an exemplary Standard Configuration Menu for the Desktops Product Category.

FIG. 11 is an exemplary Standard Configuration screen for the first standard configuration of the Desktop product category.

FIG. 12 is an exemplary Shopping Cart screen.

FIG. 13 is an exemplary Route Order screen.

FIG. 14 is an exemplary Templates screen.

FIG. 15 is an exemplary selected Template screen.

FIG. 16 is an exemplary Order Search Results screen.

FIG. 17 is an exemplary Purchase Order screen.

FIG. 18 is an exemplary Order Screen.

FIG. 19 is an exemplary Reports Screen.

### DETAILED DESCRIPTION OF THE INVENTION

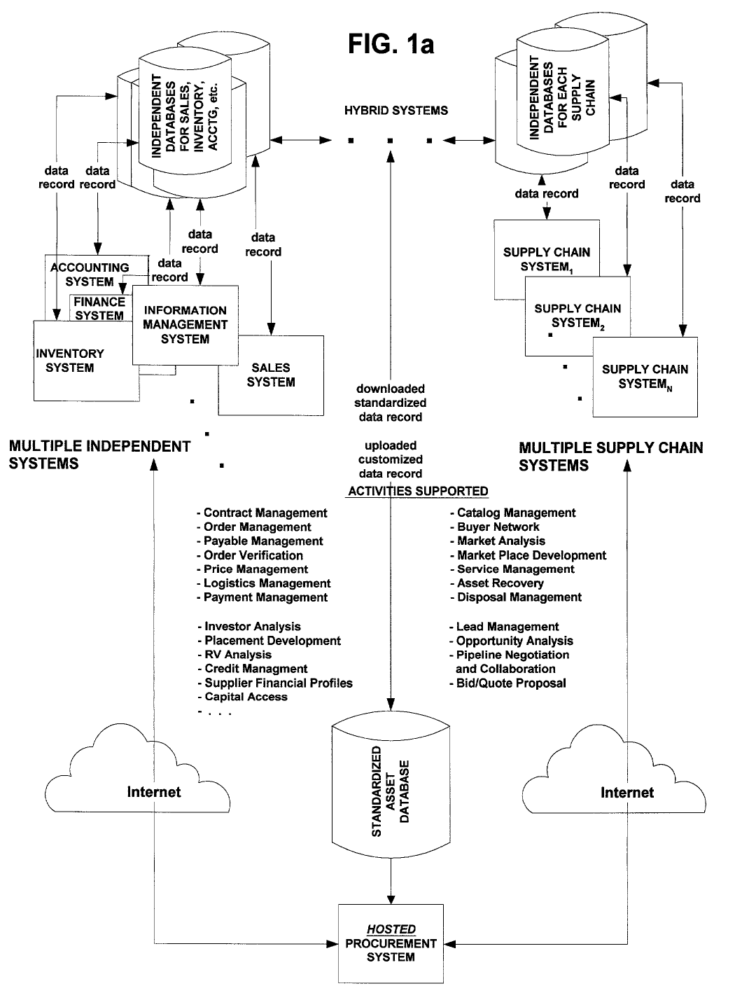

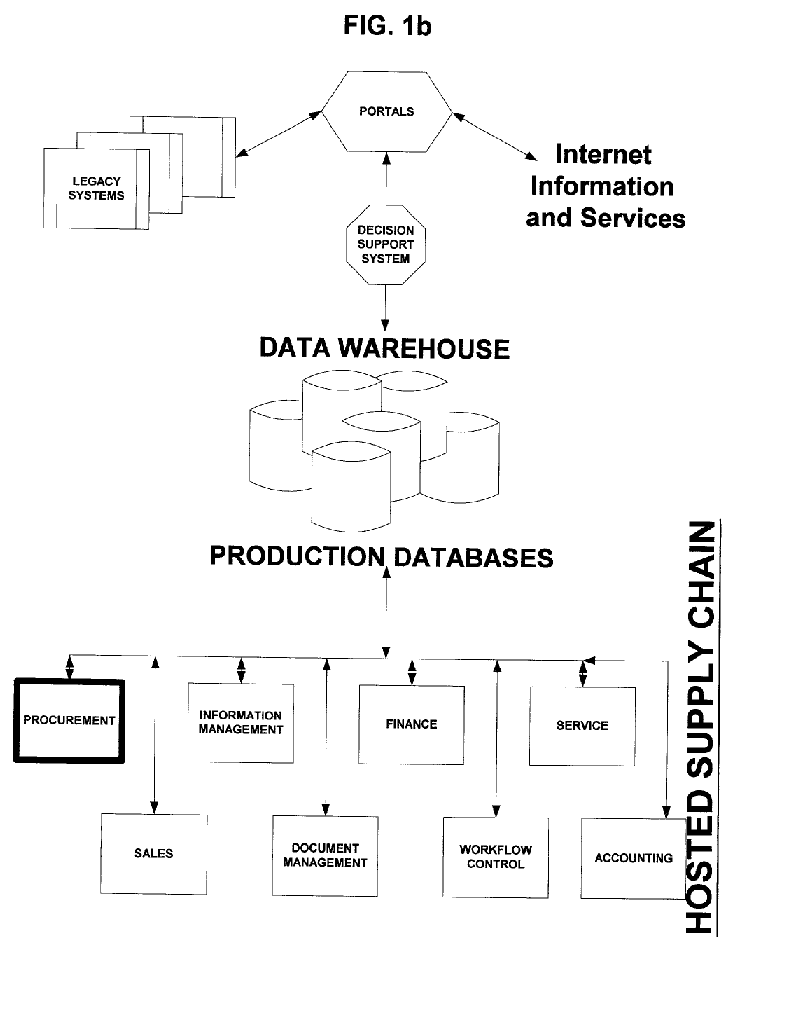

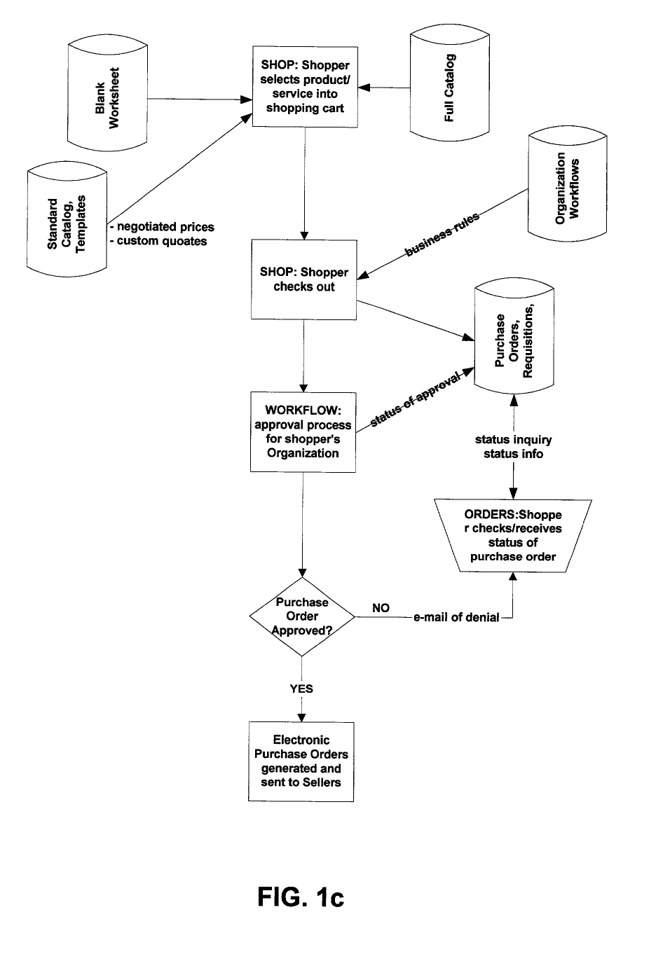

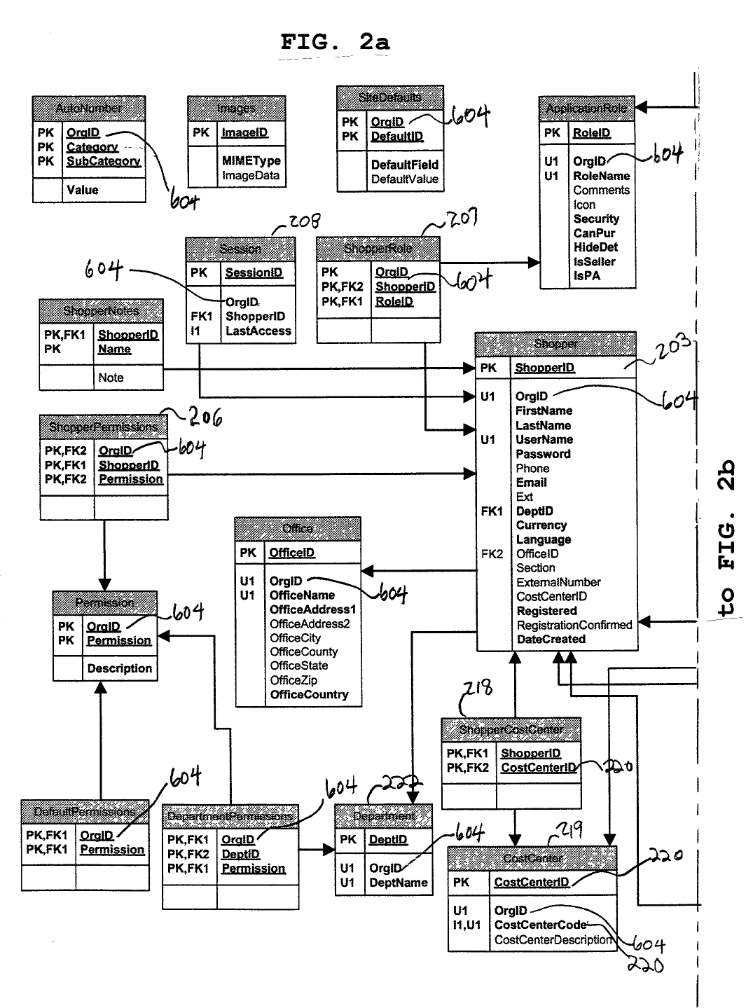

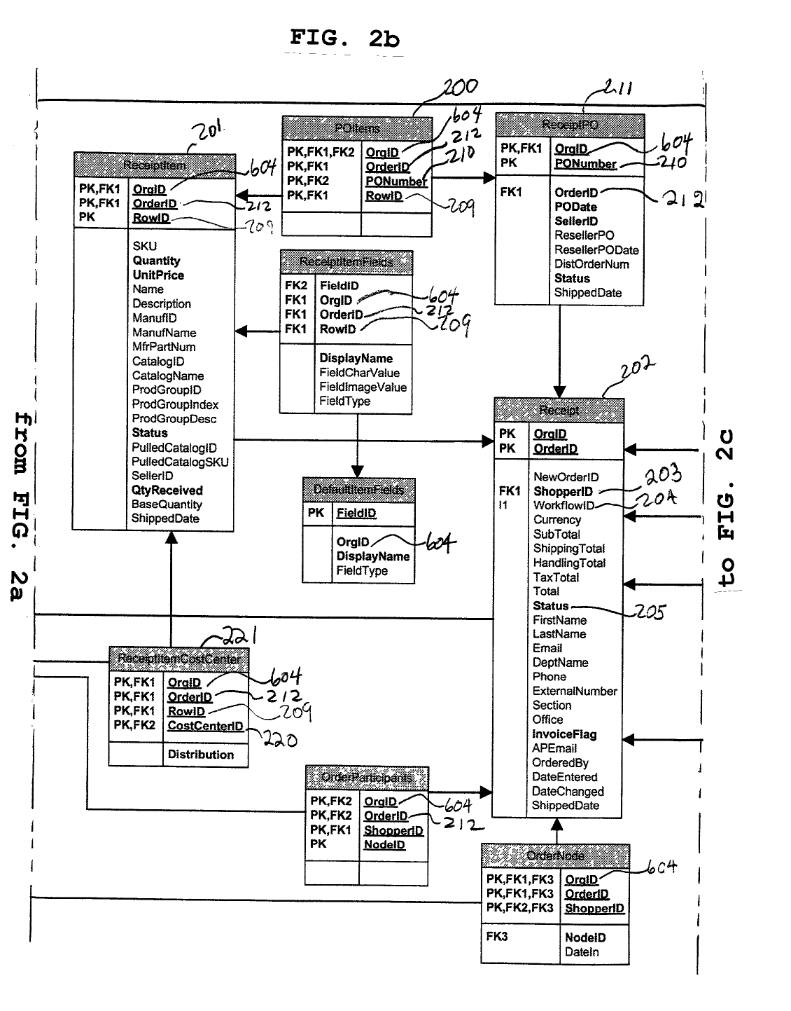

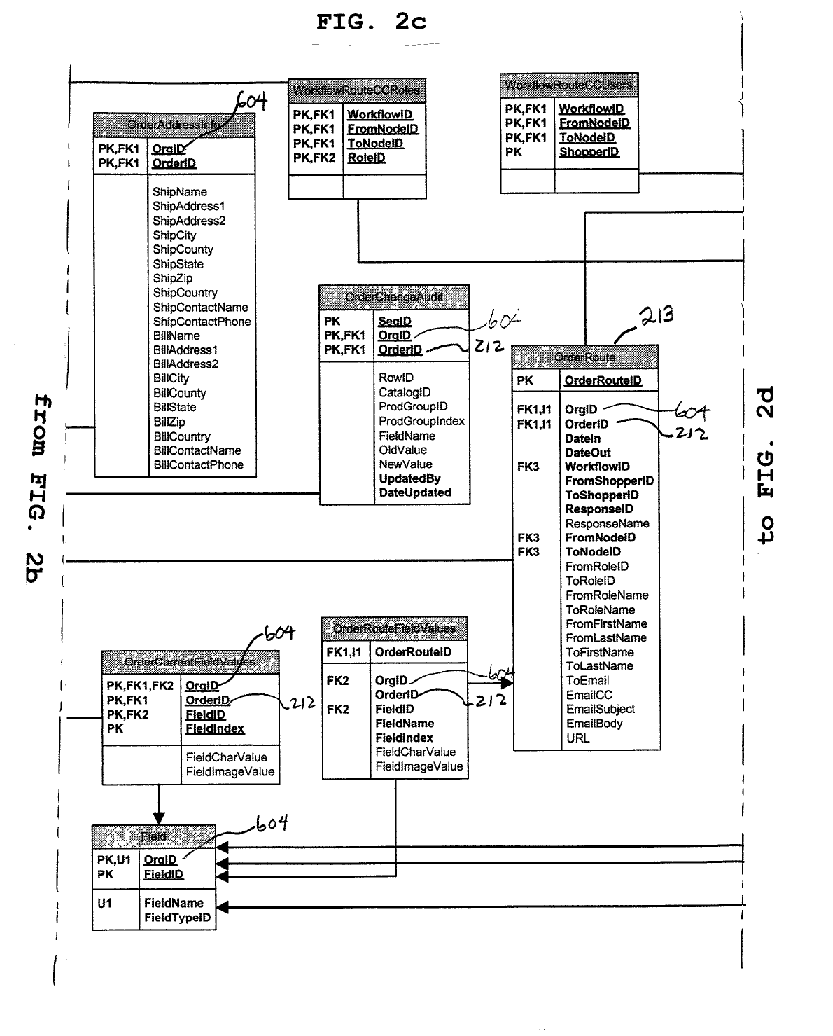

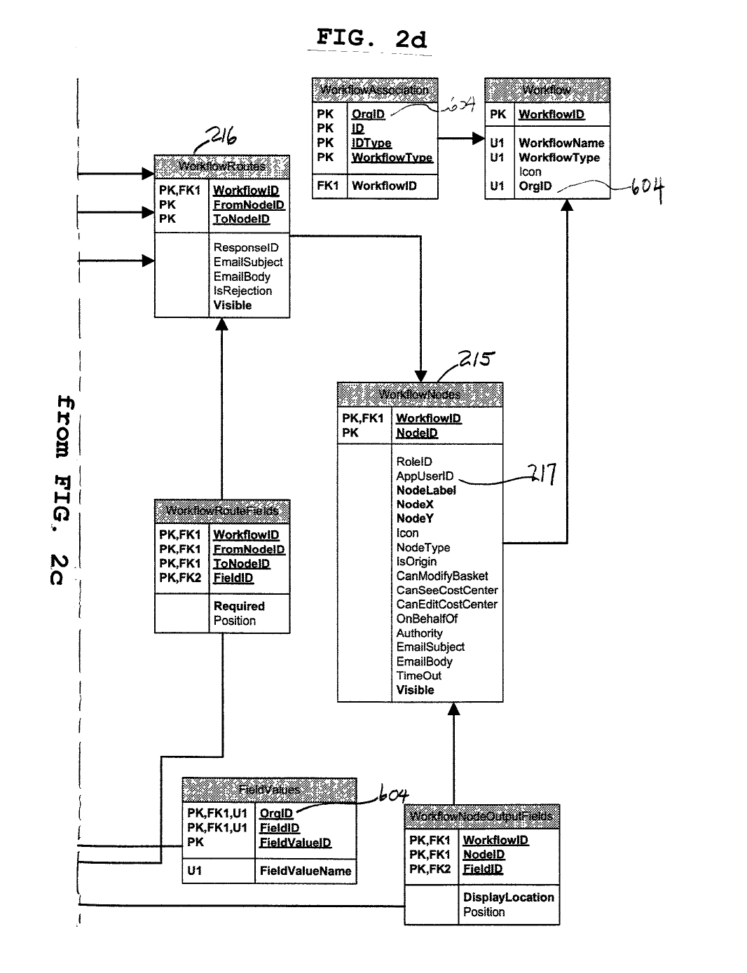

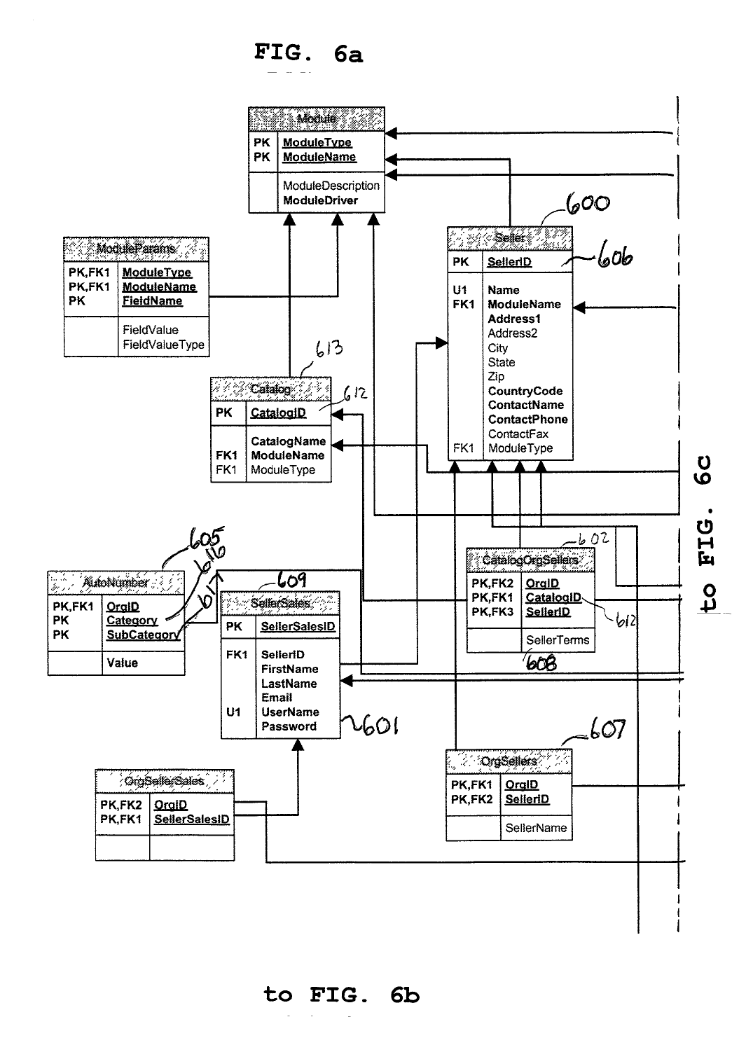

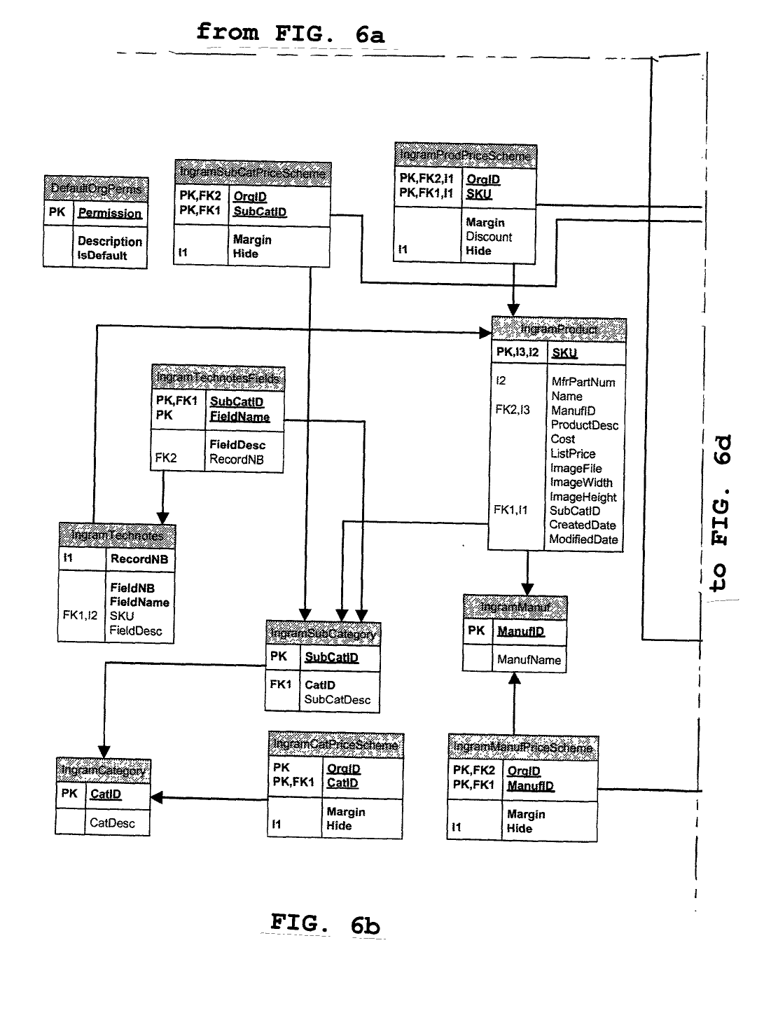

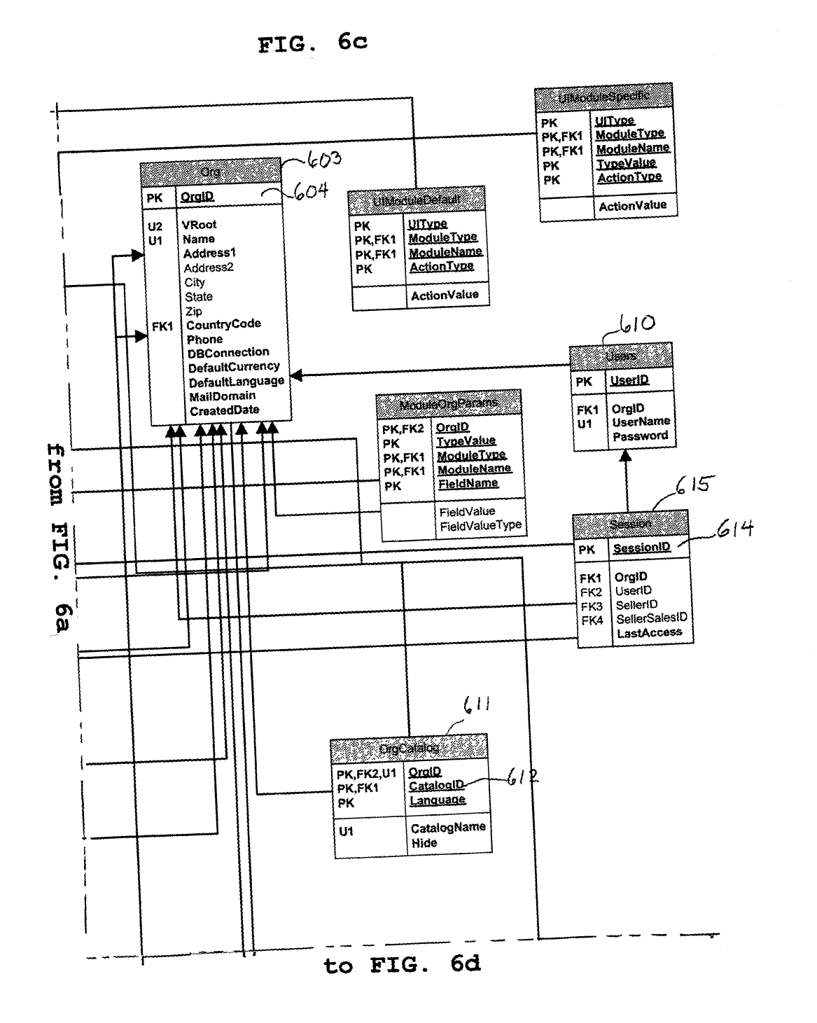

The present invention provides a hosted Internet accessible web-based system and method for asset procurement. A general asset selection and ordering process is particularized to each partner in a supply chain by providing each authorized shopper for that partner with a catalog of authorized products and negotiated prices and enforcing the partner organization's business rules or workflows for approval of the authorized shopper' purchases, as illustrated in FIG. 1c. Procurement information is captured in a database, as illustrated by database schemas of a preferred embodiment illustrated in FIGS. 2a-d and FIGS. 6a-e. Shopper purchase orders are stored in the POItems table 200, and seller purchase orders are stored in the SellerPO table 622 and line items are stored in the SellerPOItems table 623. The intent of this preferred embodiment is that it be used by other independent systems as well as by the hosted procurement system and method of the present invention.

The range of features and functionality provided by a preferred embodiment of the present invention includes:

familiar shopping cart metaphor for online shopping;

creation of purchase templates for frequently ordered configured products;

creation of multiple purchase orders from a single requisition;

customized workflows to automate an organization's procurement approval process;

managed secure user access;

integration with partner' online catalogs;

customized standard products catalog for each partner organization;

orders routed anywhere in the organization using bill-to, ship-to and office addresses;

configure an organization's cost centers;

enhanced order status, including created electronic purchase orders; and

comprehensive reporting.

In a preferred embodiment, a relational database is used to organize and store procurement information.

### Procurement Database

In a preferred embodiment, business rules for each supply chain partner are stored in a relational database. These rules modify the standard procurement process of the system and method of the present invention to become a custom procurement process, as illustrated in FIG. 1c. When a shopper, as a member of a partner organization, procures an asset using the system and process of the present invention, that asset is placed onto a schedule and stored in the shopper database, illustrated in FIG. 2, as an item to be received in ReceiptItem table 201. Each such item also appears in the POItems table 200. The POItems table 200 lists the line item detail of each purchase order. The Receipt table 202 records the name of the shopper in the ShopperID field 203 and the workflow to be used for approval of the purchase in the WorkflowID field 204. The approval status is entered in the Status field 205.

The business rules associated with a customer determine whether or not the schedule may close with each item procured or may remain open for inclusion of additional items until some predefined closing condition is met. During the period in which a schedule remains open, it is billed on a daily basis for any outstanding items. Once the schedule is closed, no further items may be added to it and billing takes place on a periodic basis, usually monthly. During the time the asset remains in the possession of the customer, there may be other charges associated with the asset, e.g., maintenance and options. Further, the asset will be physically located at a location and possibly associated with a cost center.

In a preferred embodiment, asset procurement information associated with schedules and other activities that is captured in a relational database comprises several types of information, including:

CATALOG

SELLER

SHOPPER

WORKFLOW

ORGANIZATION

Relational database schemas contain at least three types of relations or tables: constant tables, working tables, and cross-reference tables. Primary keys (PK) are table fields, used in searches of a table, that have been called out in an index for the purpose of speeding up table searches. Foreign keys (FK) are used to cross-reference to one set of tables with another set of tables. For example, the Seller table 600 has a Primary key of

### Catalog

In the hosted procurement system and method of the present invention an electronic catalog is provided to customers. In a preferred embodiment, this catalog is implemented using a relational database whose schema is illustrated in FIG. 6a, 6c and 6e. In this database each partner organization is represented by a record in the Org table 603 in which each partner organization has been assigned a unique identification number, OrgID 604.

Associated with each partner organization is a standard catalog that a partner populates with data concerning the products approved for purchase by its organization's authorized shoppers. In a preferred embodiment, standard product catalogs are listed in the Catalog table 613 and each catalog is uniquely identified by CatalogID 612. The relationship of a partner organization to its catalog is represented in the cross-reference table OrgCatalog 611.

Standard product categories contained in StdCategory Table 619 are identified by CategoryID 616, and subcategories are identified by SubCategory 617. For each partner organization that procures products, standard product categories are used to group products into standard configurations in the StdProductGroup table 620 by a unique product group identifier, ProdGroupID 621.

The relationship between organization, category, and subcategory is represented in the AutoNumber table 605. The hierarchal relationships of products for an organization is represented by ParentCategoryID 618 in the StdCategory table 619.

Thus, there are two representations of the standard category hierarchy for each organization: AutoNumber table 605 and StdCategory table 619.

Each product in a catalog has one or more standard configurations, represented by one or more corresponding entries in the StdProductGroup table 620. Each standard configuration has one or more attributes represented by entries in the StdProdGrpAttr table 624. An attribute describes a component of the corresponding standard configuration, i.e., a product a shopper has to purchase in order to obtain a standard configuration for another product. The actual items which correspond to attributes are represented in the SKU table 625.

Several suppliers can supply each attribute, as indicated by multiple SKU table entries corresponding to a given attribute. Each supplier can have unique pricing for each procuring organization. The database schema illustrated in FIG. 6b illustrates a catalog schema for Ingram products.

### Seller

Products are sold by a seller partner listed in Seller table 600, in which each seller has been assigned a unique identification number SellerID 606. They are related to other partner organizations by the OrgSellers cross-reference table 607 and a seller that is authorized to sell products contained in a partner organization's catalog is related to both the partner organization and the partner's catalog by the CatalogOrgSellers table 602. The CatalogOrgSellers table 602 also contains the SellerTerms 608. Each seller organization also has a sales force contained in the SellerSales table 609, and members of this sales force are also users of the hosted procurement system of the present invention and have signon information associated with a unique user identification contained in the Users table 610. In this embodiment, all users of the hosted procurement system of the present invention interact with this hosted procurement system in a session uniquely identified by SessionID 614 and recorded in Session table 615.

### Shopper

In a preferred embodiment, a shopper database is maintained to identify shoppers that are authorized to make purchases on behalf of partner organizations, to represent the structure of a partner organization, to represent the purchase approval workflow through that structure, and to track purchases (receipts). An exemplary Shopper database schema for a preferred embodiment is shown in FIG. 2a-d. This Shopper database schema is related to the Catalog database schema via OrgID 604, the shopper's organization identifier, and the Org table 604.

Each shopper has various permissions listed in the ShopperPermissions table 206 and performs various roles in the approval process as listed in the ShopperRole table 207. Every time a shopper uses the hosted procurement system of the present invention, an entry is made in the Session table 208. Each item the shopper ‘purchase’ from the organization's catalog becomes a line item or RowID 209 in a purchase order identified by PONumber 210 listed in the POItems table 200. The ReceiptPO table 211 lists the purchase orders identified by organization OrgID 604. Each purchase order may result in multiple orders being placed with different sellers and each such order has a unique OrderID 212. For each organization, the orders associated with a purchase order are listed in the ReceiptPO table 211 and details for each line item in each order placed are contained in ReceiptItem table 201.

The approval Status 205 of each organization's orders is maintained in the Receipt table 202 along with the WorkflowID 204 of the approval process.

### Workflow

The Workflow feature of the present invention enables an organization to incorporate its purchase approval processes into the hosted procurement system of the present invention, thus automating the workflow process and seamlessly integrating it with procurement.

In a preferred embodiment, each staff member who approves orders in a partner organization can be sent e-mail when an order is placed requiring that staff member' approval. The role a staff member plays can be set, e.g., Approve or Deny. If a staff member denies an order a notice is sent to the staff member who placed the order. If a staff member approves an order this approval is sent to the next appropriate staff member in the organization's workflow process.

In a preferred embodiment, each shopper has an associated purchase approval process or workflow. When the shopper places an order with a seller, this workflow is entered into the OrderRoute table 213 for routing the order to various nodes for approval. A workflow is a network of nodes listed in WorkflowNodes table 215 connected by FromNodeID ToNodeID listed in WorkflowRoutes table 216. All the nodes in a workflow network must be visited and approval obtained from the member corresponding to AppUserID before an order is accepted.

### Organization

Partner organizations can be organized as cost centers and departments and offices. These various organizational entities have different uses, in a preferred embodiment.

A shopper selects a cost center to assign to each purchased product. Cost centers available to a shopper for assigned to purchases are listed in the ShopperCostCenter table 218 which 25 references the CostCenter table 219 by the CostCenterID 220. The cost center assigned to a purchased product is listed in the ReceiptItemCostCenter 221 and identifies the line item by RowID 209.

Departments are administrative divisions of a partner organization and are listed in the Department Table 222. In a preferred embodiment, a department has a default workflow associated with it, and shoppers are associated with departments and inherit the default workflow assigned to the department.

### Procurement

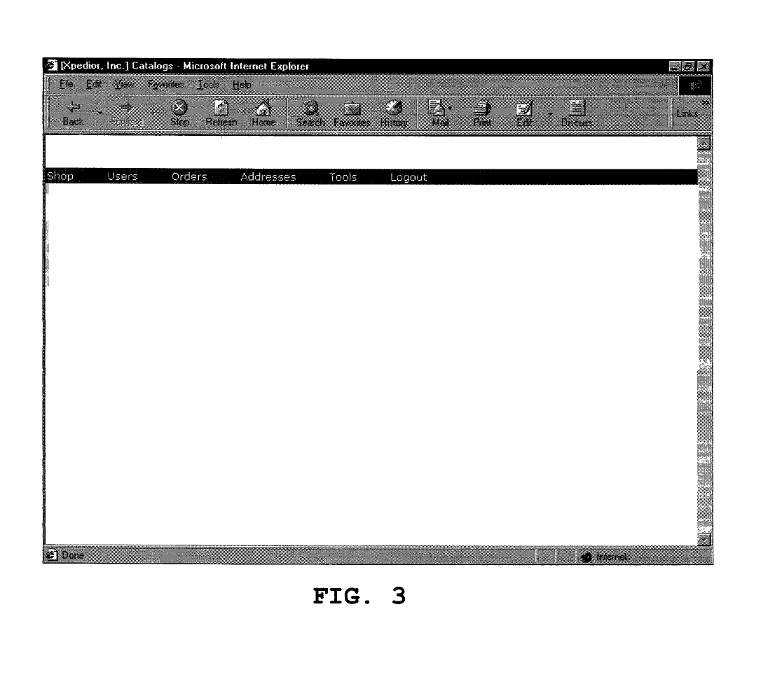

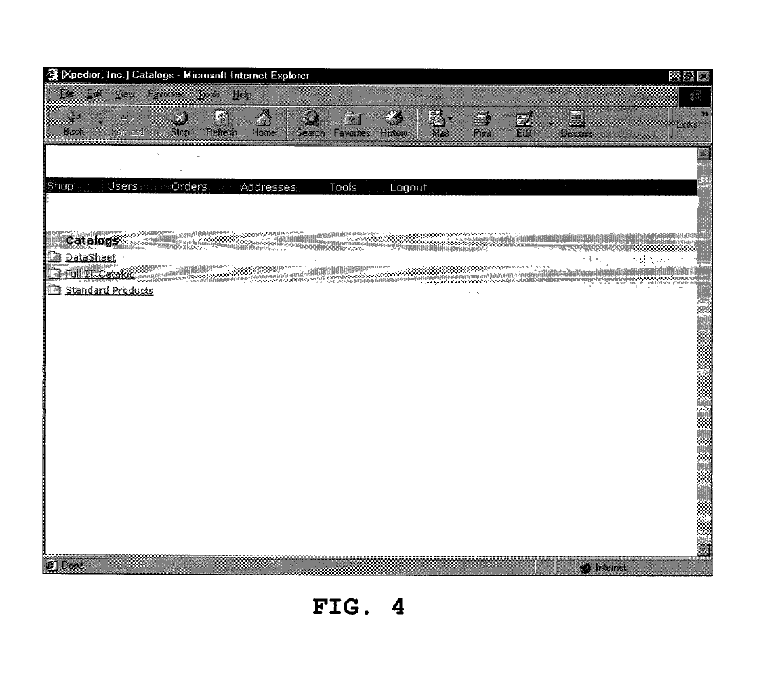

In a preferred embodiment, there are three classes of functions provided: shopping, ordering, and tools. In this preferred embodiment, a user is presented with a Home web-page containing a main menu bar, as illustrated in FIG. 3, which contains:

Shop,

Orders,

Tools, and

Logout

as selection options.

### Shop

In a preferred embodiment, the basic steps a user follows to use the procurement system of the present invention are:

1. Select a catalog. After a user logs on the user is taken immediately to the Shop screen and the Catalogs Menu appears. The Catalogs Menu provides access to the online catalogs the user's organization has made available to the user.

2. Select a product. After the user has selected a catalog, the user can search the selected catalog for the desired products.

3. Add products to shopping cart. The present invention employs the familiar shopping cart metaphor. When a user finds a desired product, the user uses the Add to Cart option to add the product to the user's shopping cart.

4. Check Out. When the user has finished making selections, the user is ready to check out. The user selects the Check Out option and enters payment information and is provided an order confirmation.

5.

Status Check. After the user has placed an order by following the above steps, the Orders feature can be used to check the status of an order.

The Catalogs feature is accessed by selecting the Catalog command from the Shop menu, in a preferred embodiment. This feature enables the user to view the online catalogs the user's organization has made available to the user.

In a preferred embodiment, the Catalogs feature enables an organization to customize each catalog it makes available to users. By customizing its catalogs, an organization can provide users with access to the range of products approved for use by the organization.

FIG. 4 illustrates the Catalogs Menu according to a preferred embodiment. As the central screen of a preferred embodiment of the hosted procurement system of the present invention, the Catalogs Menu provides access to a user's customized online catalog. Each catalog provides options for searching for products, viewing product information, and adding products to the user's shopping cart.

The Catalogs Menu of a preferred embodiment offers three options:

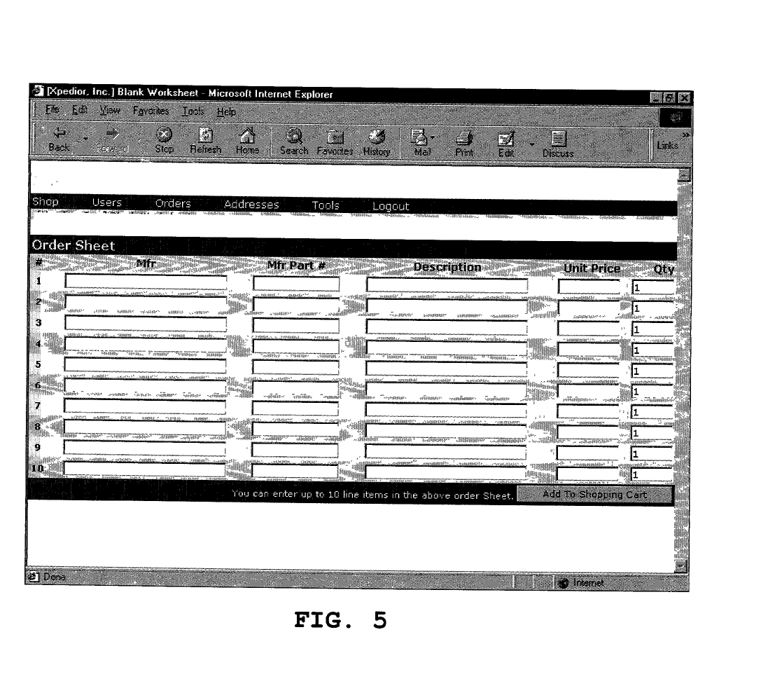

1. Blank Worksheet: The Blank Worksheet feature, illustrated in FIG. 5, enables a user to select a product by entering product 30 information instead of searching for the product from a catalog.

To employ the Blank Worksheet, the user enters the manufacturer name and number, description, and unit price of a product. The Blank Worksheet feature provides a convenient way to order products not yet available from the catalogs provided by the hosted procurement system of the present invention.

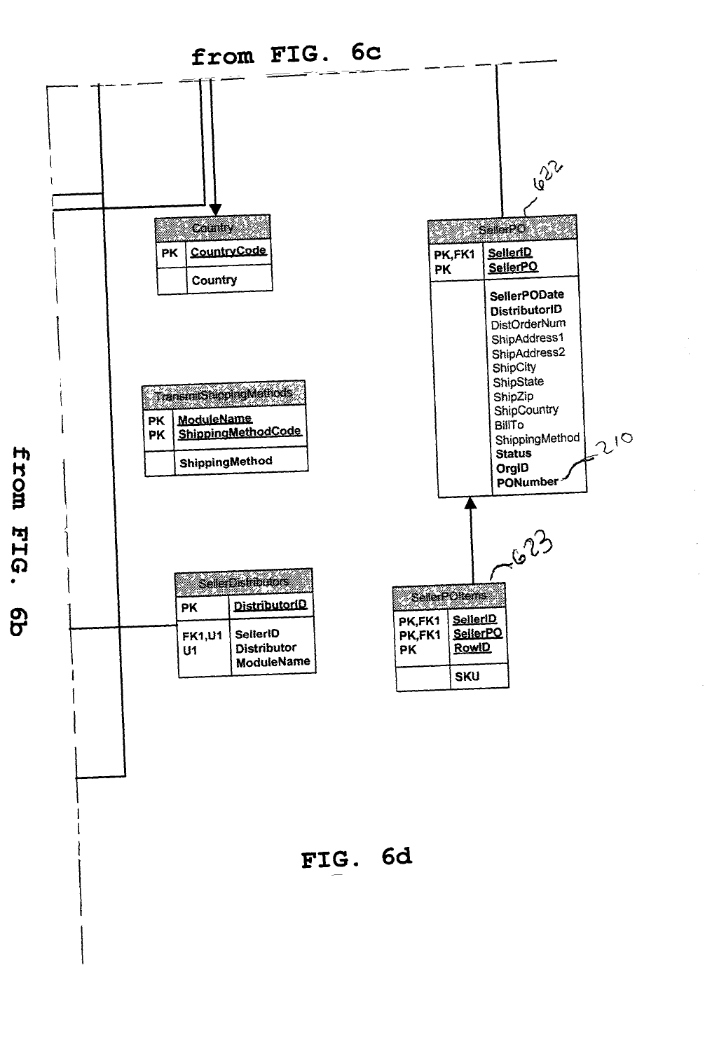

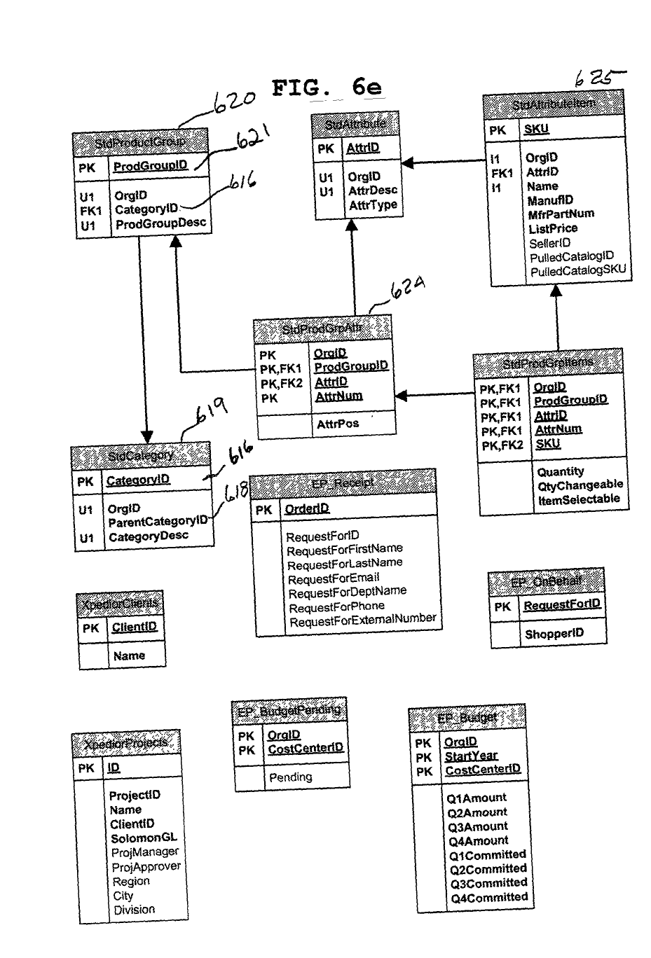

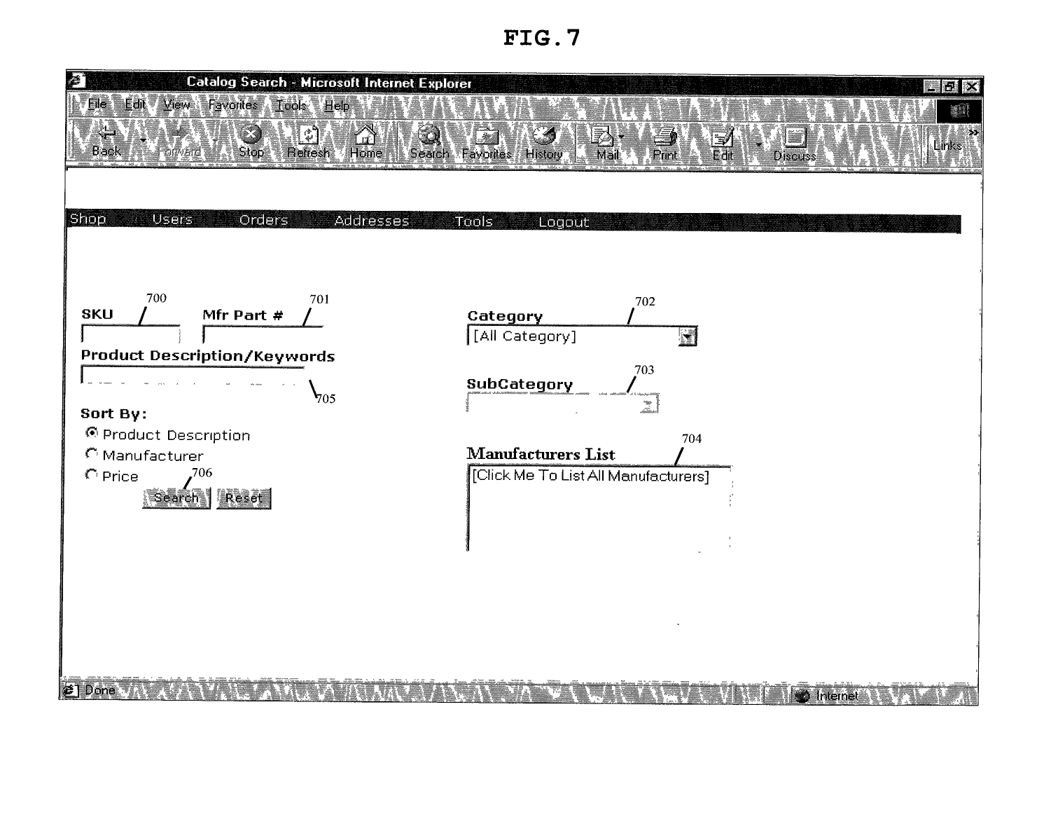

2. Full Catalog: The Full Catalog is the complete online catalog that is the built-in default catalog of the hosted procurement system of the current invention. FIG. 7 is an exemplary Product Search Screen for searching the Full Catalog. The user proceeds as follows:

a. SKU 700 or Manufacturer Part # 701 is entered to search on these items.

b. A search may be limited to a product category 702 or subcategory 703 by making selections from the corresponding dropdown menus.

c. A search may be limited to the products of a given manufacturer by selecting that manufacturer from the Manufacturer drop-down list 704.

d. The Product Description/Keyword field 705 enables a user to search for products by keyword(s), including searching for multiple keywords. Keywords may be anded and ored to find all the products with the given keywords or at least one keyword, respectively.

e. Under Sort By the user may select the ordering of search results.

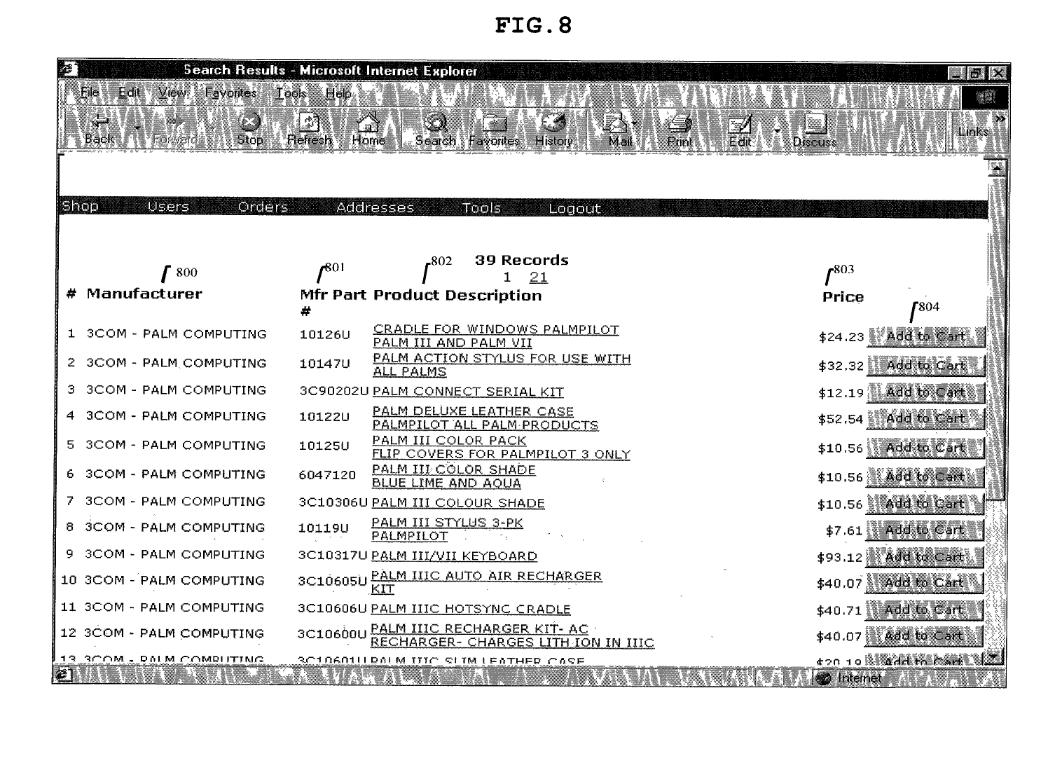

f. Clicking Search 706 causes the hosted procurement system according to the present invention to display the search results in the Product List Screen illustrated in FIG. 8. From the Product List Screen a user can view a detailed description of a selected product, or add a product to the user's shopping cart.

Product Options in the Product List Screen:

The manufacturer name 800, manufacturer part number 801, product description link 802, price 803, and Add to Cart 804 option appear for each listed product.

Product Link: displays a detailed description of the selected product. Clicking on the Product Link causes a description of the product to appear.

Add to Cart: Adds the selected product to the user's shopping cart. Clicking on the Add to Cart option adds the corresponding product to the user's shopping cart. The Shopping Cart command from the Shop menu is used to view the contents of a user's shopping cart.

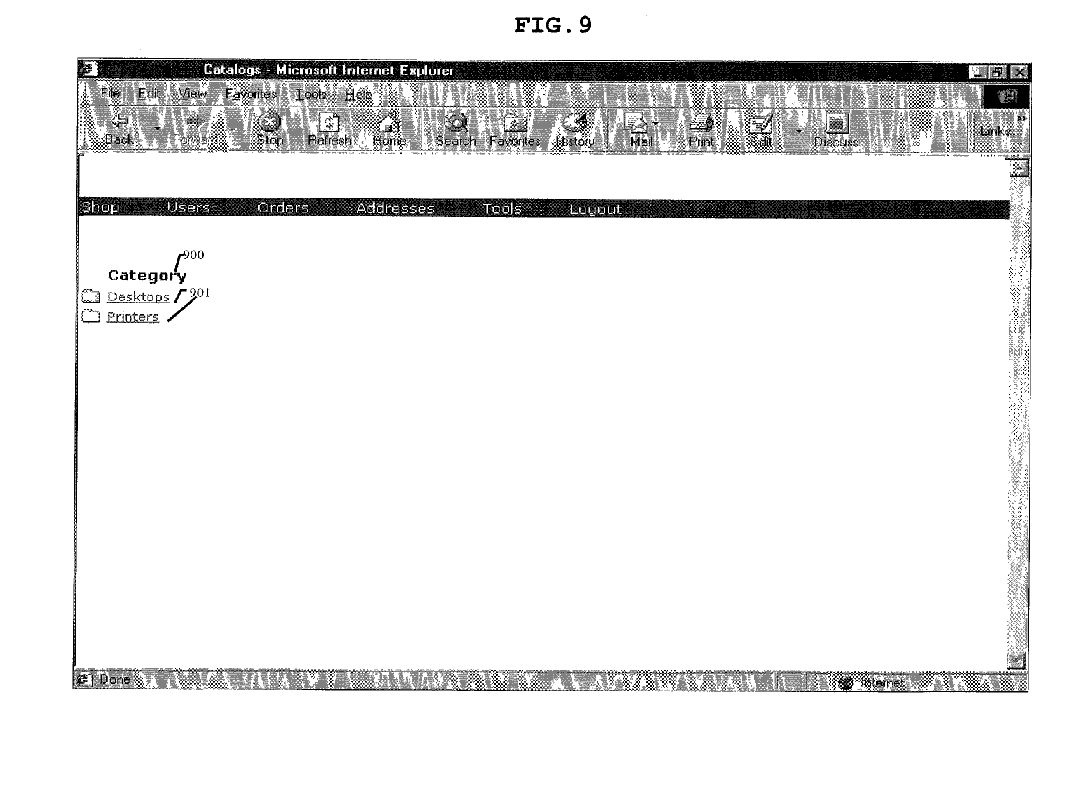

3. Standard Products: The Standard Products Catalog has been customized by the user's organization to contain the products approved for purchase by the organization's shoppers. In an embodiment an organization designed its Standard Products Catalog to include eight product categories—CAD PC, Desktops, Plant PC, Scale System PC-Desktop, Server Options, Servers, The Startup Kit Bundle, and Workstation. In a preferred embodiment, these would be listed in the Category Menu 900 of the Standard Products Catalog, illustrated in FIG. 9.

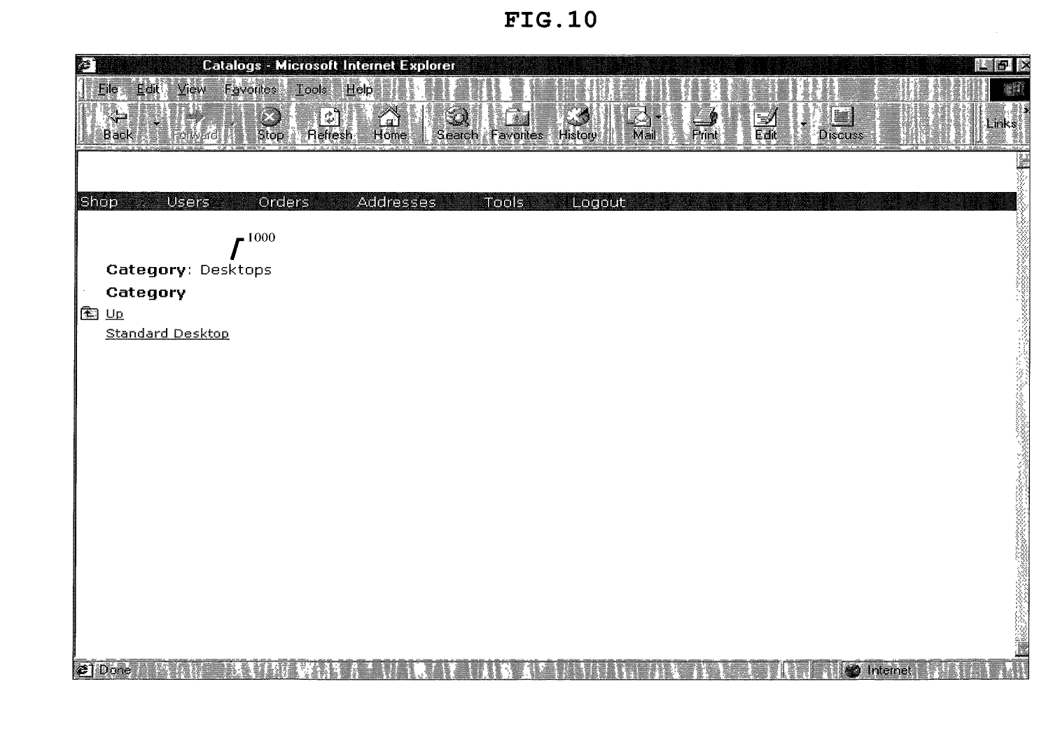

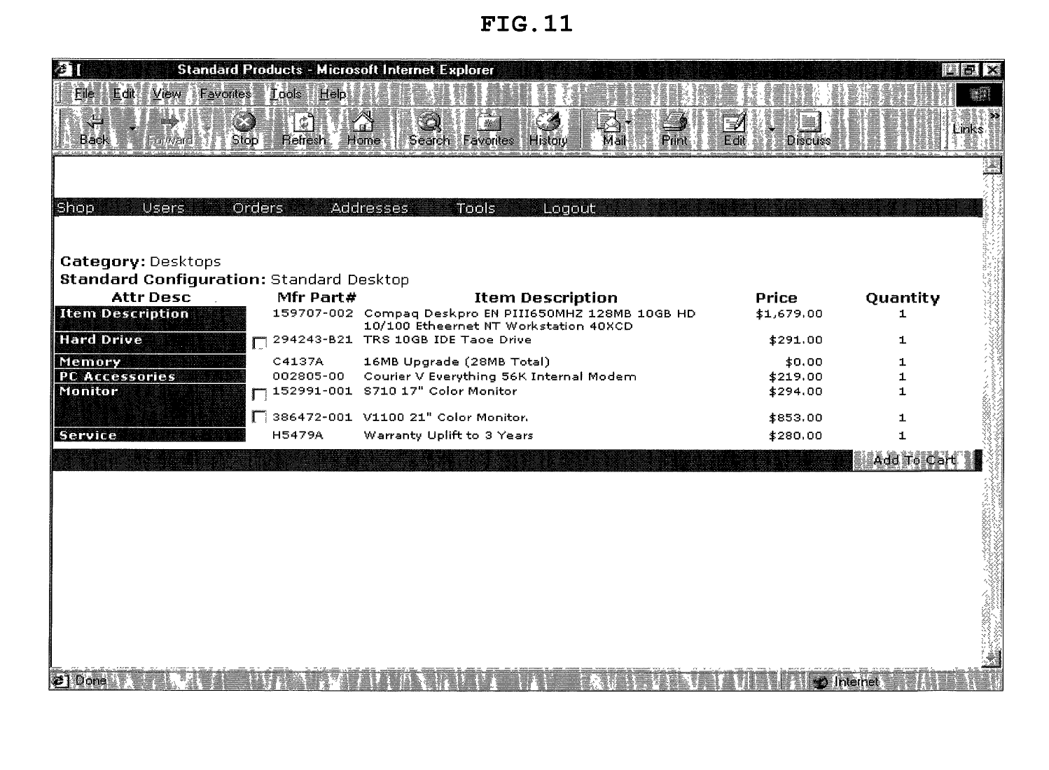

In a preferred embodiment, a list of a standard products for a category is obtained by clicking on the category link 901 in the Category which causes the Standard Configuration Menu for the product category to be displayed, as illustrated for the Desktop Category 1000 in FIG. 10. In a preferred embodiment, clicking on a standard configuration for the category causes a display of the detail of the configuration, as illustrated for the first standard configuration for Desktops in FIG. 11. The standard configuration can be added to the user's shopping cart by clicking on the Add to Cart option.

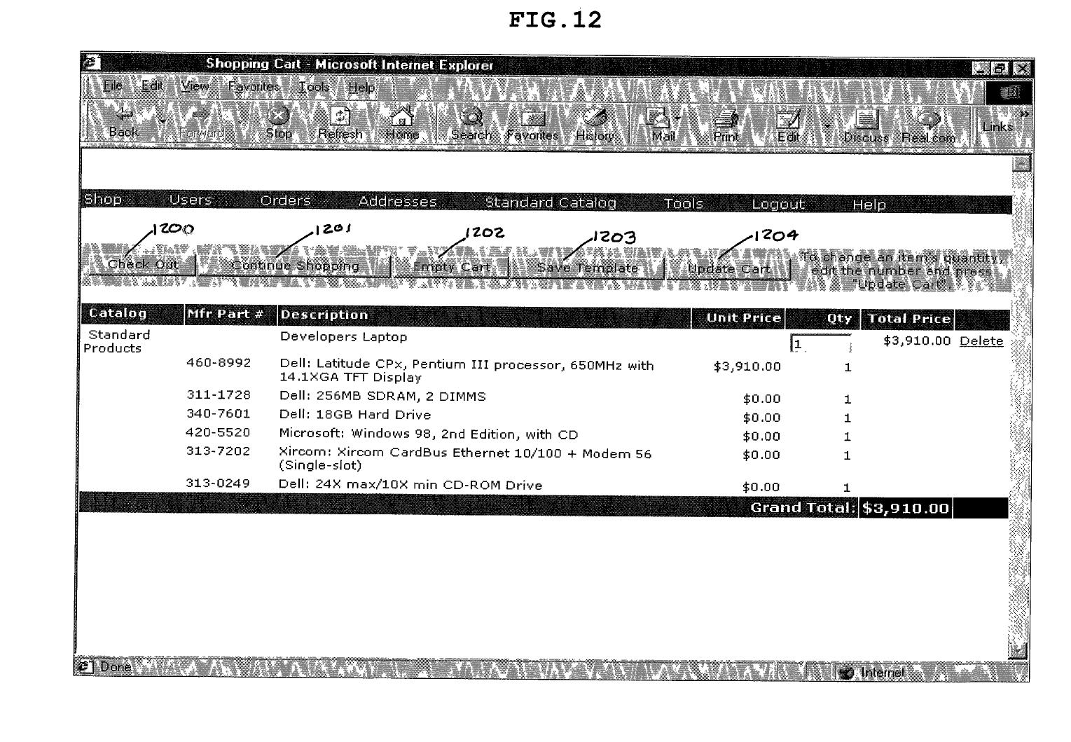

A preferred embodiment of the present invention uses the familiar shopping cart metaphor. In this embodiment, the user may view the shopping cart by selecting Shop from the main menu bar and then selecting Shopping Cart, which causes the display of the user's shopping cart, as illustrated in FIG. 12.

The Shopping Cart Screen offers the shopper the following options in a preferred embodiment:

a. Check Out 1200: to check out with the products in the shopping cart. When this option is selected, in a preferred embodiment, the Route Order Screen appears, as illustrated in FIG. 13, and in a preferred embodiment prompts the shopper to enter:

1. From the Bill-to drop-down menu, the address at the shopper's organization that a vendor is to send a purchase order for the order;

2. From the Lease Term drop-down menu, the term of the lease;

3. Depending on whether the order is a purchase or included under a lease agreement, in G/L: Charge code (Purchase) or G/L Charge Code (lease), the General Ledger charge code the user wants to charge the order to;

4. In PO #, the purchase order number for the order;

5. In Purchase/Lease, whether the order is a purchase or included under a lease agreement;

6. From the Ship-to drop-down menu, the address the shopper wants the order delivered to;

7. In the Shared G/L Charge Code box, if applicable, any General Ledger charge code(s) the order should be charged to in addition to the primary charge code entered in step 3;

8. In the Comments box, any additional information about the order the shopper wants to convey to the host organization;

9. From the Send-to drop-down menu, the staff that must approve the order. Selecting the Same Office or Same Department check box enables the shopper to limit the staff listed in the Send-to drop-down menu.

10. Clicking Submit to send the order to the selected staff for approval and to display a confirmation message. The confirmation message includes the requisition number assigned by the system to the shopper's order. In addition, a confirmation is e-mailed to the shopper once the order is available for use with the Orders option in the main menu bar for the shopper to check the status of the order.

b. Empty Cart 1201: to empty the shopping cart;

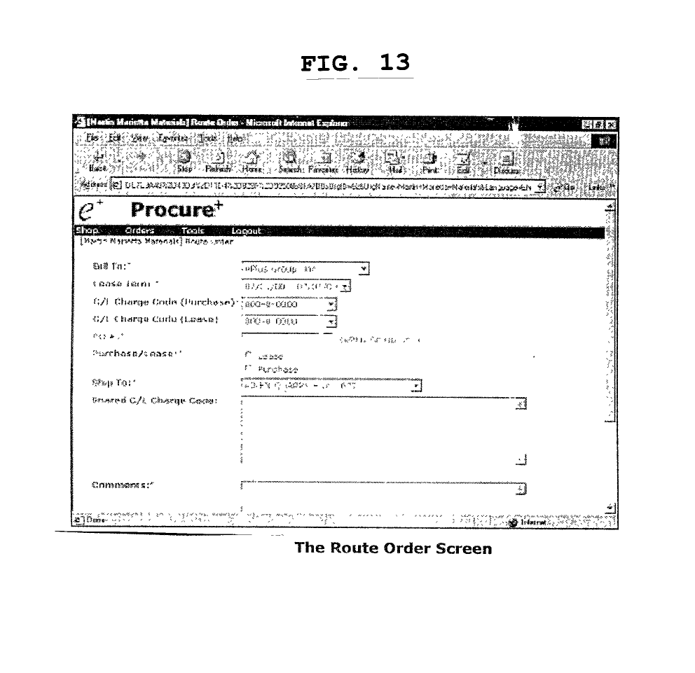

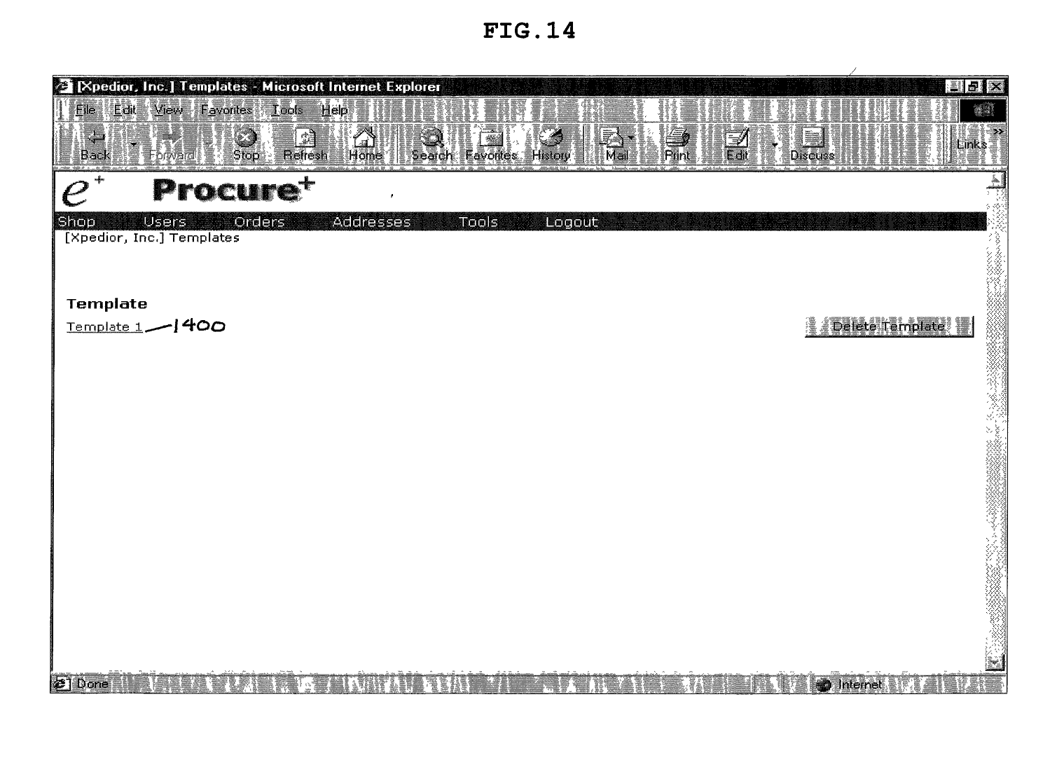

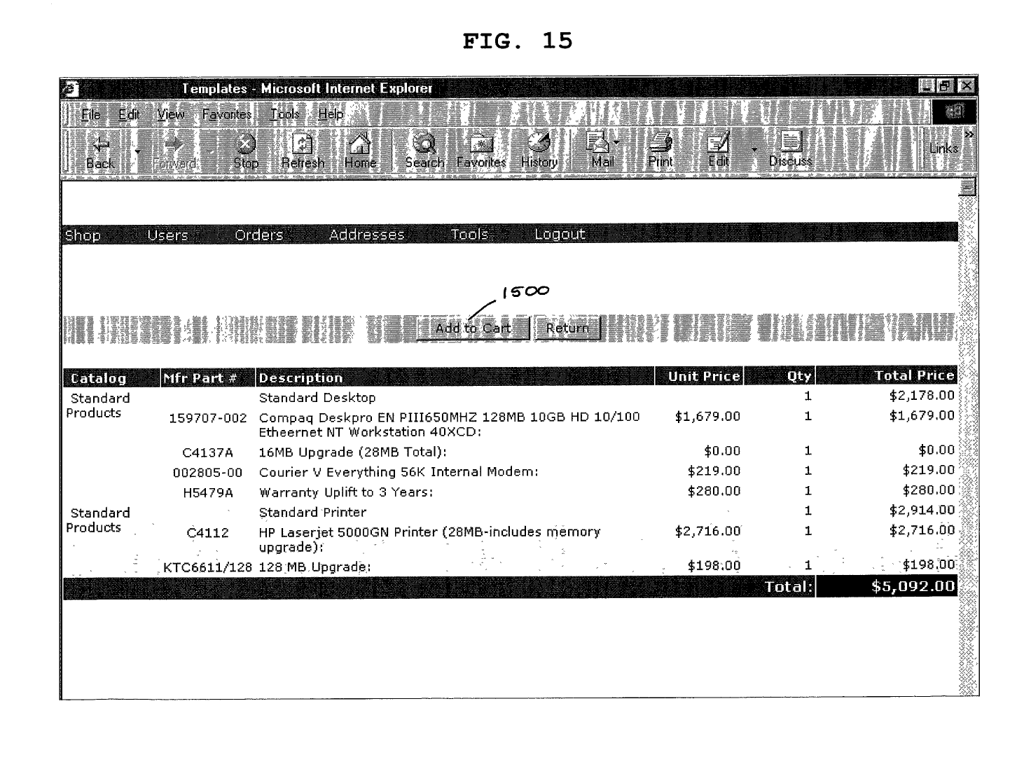

c. Save Template 1202: to save the contents of the shopping cart as a purchasing template for future use. In a preferred embodiment, saved templates may be viewed by selecting Shop from the main menu and then selecting Templates, which causes all saved templates for the organization to be displayed, as illustrated in FIG. 14. A shopper may add a configuration corresponding to a saved template to the shopping cart by clicking on the template link 1400 and when the selected template is displayed, as illustrated in FIG. 15 for a preferred embodiment, selecting the Add to Cart option 1500;

d. Update Cart 1203: to update the quantity 1204 of a product the shopper first enters the updated amount in the Quantity field 1204 and then clicks on the Update Cart option;

e. Quantity 1204: to update the quantity of a product the shopper enters the updated quantity in this field; and

f. Delete: to delete the corresponding product for the shopping cart.

### Orders

The Orders main menu selection allows a user to obtain an up-to-date status of orders placed by that user and any electronic orders placed by the hosted procurement system of the present invention. An order is referred to as a requisition after the order is placed and a user can view an order, order detail, or workflow detail; view a purchase order, or view the status of an order, including the status of each line item.

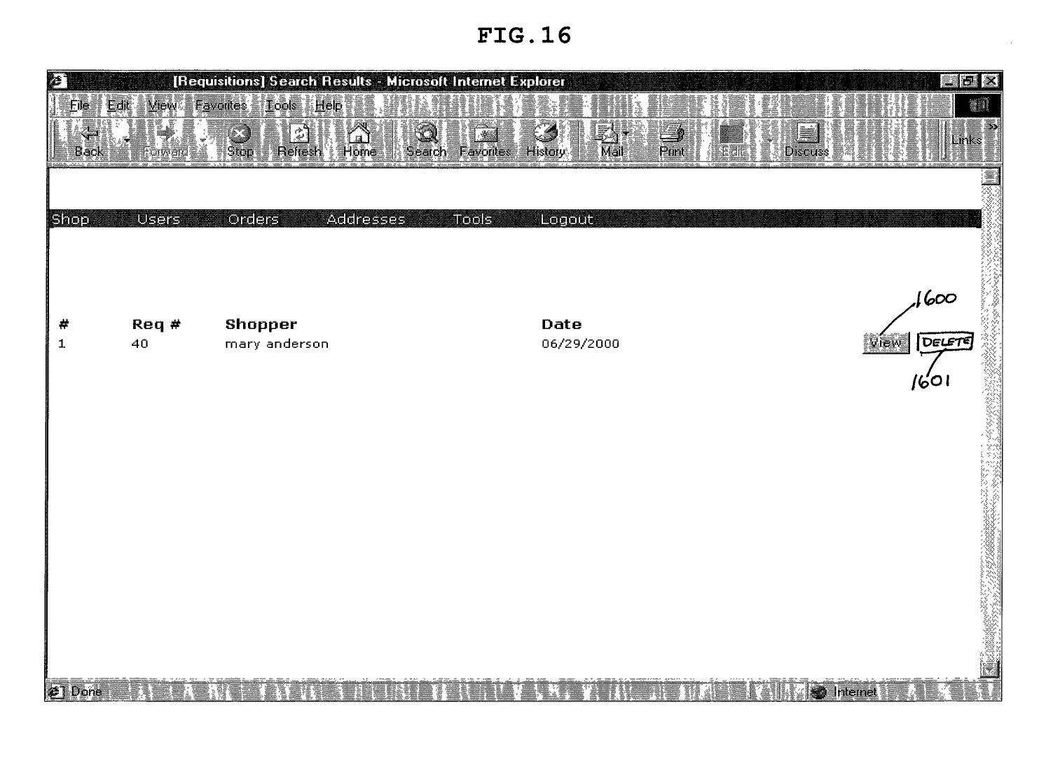

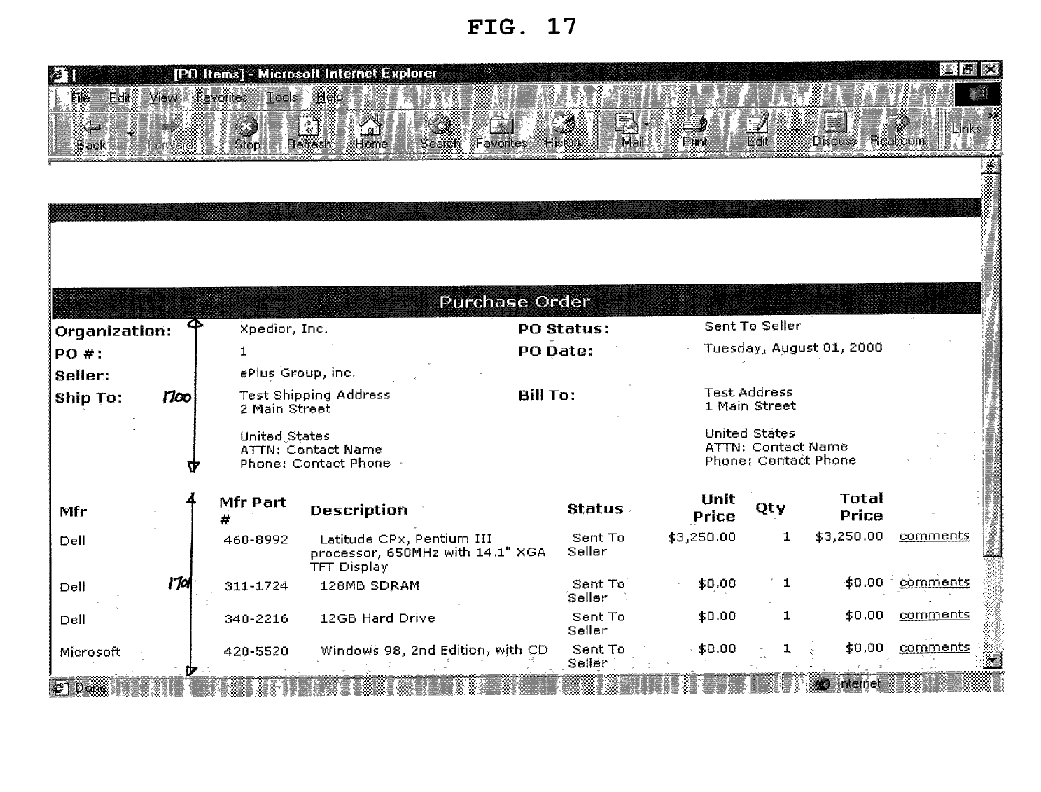

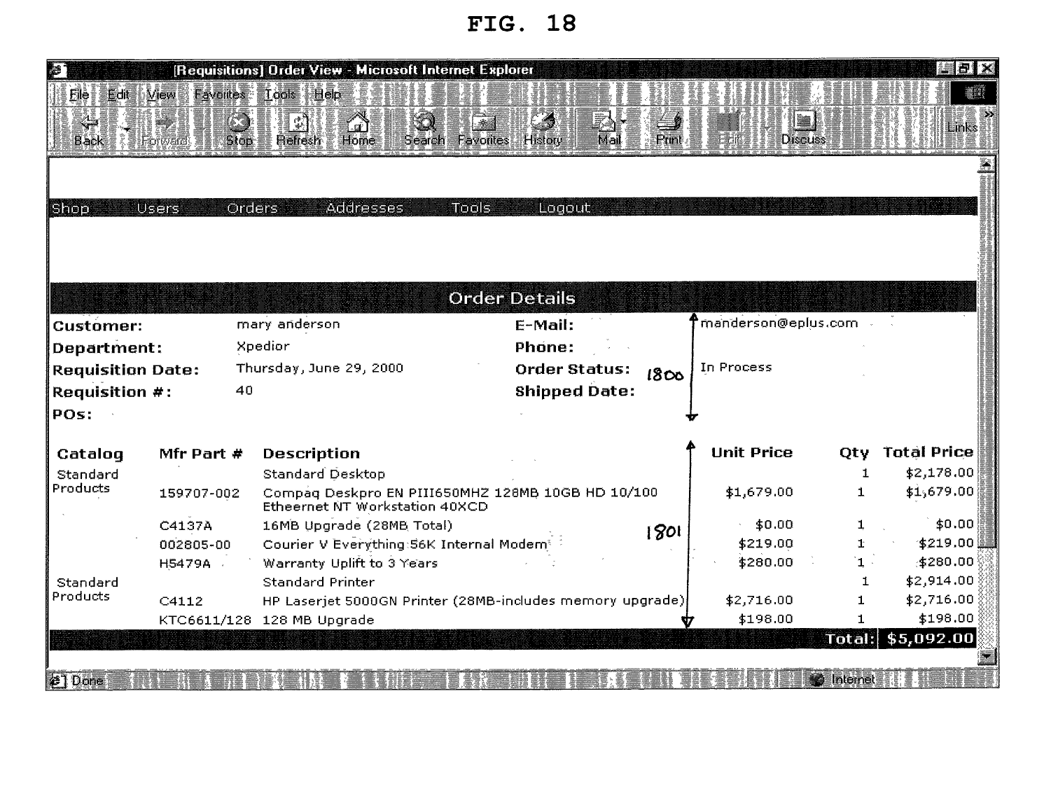

In a preferred embodiment, the Orders main menu selection provides a Search feature that enables a user to search for an order or purchase order by entering a range of search criteria. The user selects Order from the main menu and then selects the type of order to search for. In a preferred embodiment, a list of search criteria appears which the user fills-in and then clicks Search. A list of requisitions or purchase orders that match the entered criteria is displayed, as illustrated in FIG. 16. The user clicks the View option 1600 and the Purchase Order Screen, FIG. 17, or the Order Screen, FIG. 18, is displayed in a preferred embodiment. If the order has not been submitted to a seller for fulfillment, the user may be delete the order by clicking on the Delete option 1601.

The Purchase Order Screen of a preferred embodiment is illustrated in FIG. 17 and consists of a purchase order section 1700 and line item section 1701. The purchase order section 1700 lists purchase order identification information, ship-to and bill-to information. The line item section includes the status of each line item and a link to any comments entered about the line item.

The Order Screen of a preferred embodiment is illustrated in FIG. 18 and consists of an Order Details section 1800 and a Workflow Details section 1801. The Order Details section lists the identification information of the staff member that placed an order, the date an order was placed, the requisition number assigned to an order, a link to the purchase order(s) created from an order, the status of an order, and each item of an order, including the catalog the item was ordered from, and the item part number, description, unit price, quantity, and total price. The Workflow Details section of the screen lists the status of an order as it progresses through the workflow the order is assigned to. The Workflow Details section of the screen lists each approval step of the workflow an order is assigned to, including the sender of an order, the recipient of an order, the recipient's response to an order, the date a recipient received an order, the date a recipient responded to an order, and a link to detail information about a recipient's response to an order.

### Tools

### Reports

The Tools main menu selection allows a user to retrieve and report on procurement information in the database. Organized by the Reports Screen, the Reports feature provides a range of requisition and purchase order reports, from standard reports to any customized reports created for a user's organization. The Reports feature enables a user to view reports, print reports, or save reports to a variety of file formats.

Available reports include the Open Purchase Orders, Shipped Purchase Orders, Shopper, Cost Center, Purchase Orders by Date, Requisitions by Date, Purchase Orders by Status, Volume by Vendor, Volume by Manufacturer, and Analysis of Time reports.

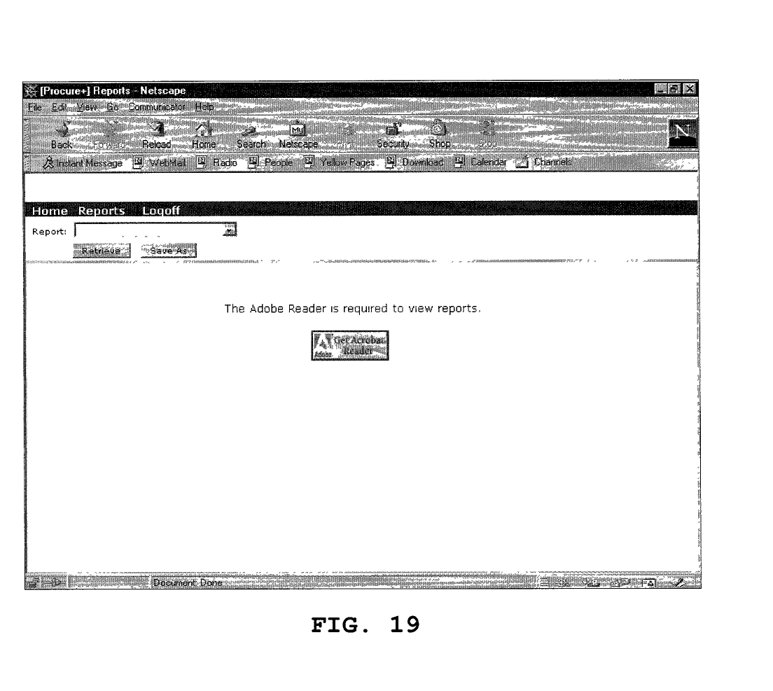

Selecting Reports from the Tools menu displays the Reports Screen, an exemplary embodiment of this screen is illustrated in FIG. 19. In a preferred embodiment, the Reports Screen comprises the Report Search feature at the top of the screen; options for producing a report and saving a report to a variety of file formats also at the top of the screen; and, the display area in the middle of the screen.

### Report Descriptions

The Reports feature of a preferred embodiment provides a user with a range of procurement information reports which include:

OPEN PURCHASE ORDERS—SUMMARY/DETAIL—enables the user to view purchase orders with a status of Open, which indicates the purchase order of a requisition that has been routed for review, but has not yet been routed to a vendor(s). The name of the user's organization, report title, and selected date range appear at the top of the report.

The Open Purchase Orders—Summary Report lists purchase orders by requisition number. The purchase order information listed in the summary report includes the requisition number, shopper, shopper department, purchase order number, purchase order date, purchase order amount, and status of each listed requisition. The report also displays the total amount of the listed purchase orders.

The Open Purchase Orders—Detail Report lists purchase orders by requisition number. The purchase order detail information listed in the detail report includes the requisition number, shopper, shopper department, purchase order number, purchase order date, purchase order amount, status, and line item detail of each listed requisition. Line item detail includes the manufacturer, manufacturer part number, description, status, unit price, quantity, and total amount of each listed line item. The report also displays the total amount of the listed purchase orders.

SHIPPED PURCHASE ORDERS—SUMMARY/DETAIL—enable a user to view purchase orders with a status of Shipped, which indicates a purchase order for which a vendor has shipped each line item of the purchase order. The name of the user's organization, report title, and selected date range appear at the top of the report.

The Shipped Purchase Orders—Summary Report lists purchase orders by requisition number. The purchase order information listed in the summary report includes the requisition number, shopper, shopper department, purchase order number, purchase order date, purchase order amount, and status of each listed purchase order. The report also displays the total amount of the listed purchase orders.

The Shipped Purchase Orders—Detail Report lists purchase orders by requisition number. The purchase order detail information listed in the detail report includes the requisition number, shopper, shopper department, purchase order number, purchase order date, purchase order amount, status, and line item detail of each listed requisition. Line item detail includes the manufacturer, manufacturer part number, description, status, unit price, quantity, and total amount of each listed line item. The report displays the total amount of the listed purchase orders.

SHOPPER—enables a user to view the purchase orders generated for a specified date range, with purchase orders grouped by shopper. The name of the user's organization, report title, and selected date range appear at the top of the report.

The purchase order detail information listed includes the requisition number, shopper department, purchase order number, purchase order date, purchase order amount, and status of the listed purchase orders of each shopper. The report also lists the total amount of the purchase orders for each shopper and the total amount of all listed purchase orders.

COST CENTER—enables a user to view purchase order line items listed by cost center for the purchase orders generated for a specified date range. The name of the user's organization, report title, and selected date range appear at the top of the report. The purchase order detail information listed includes the requisition number, shopper, shopper department, purchase order number, purchase order date, line item, line item amount, and line item status of the selected line items. The report also lists the total amount of the line items assigned to a cost center, and the total amount of all selected line items.

PURCHASE ORDER BY DATE—enables a user to view the purchase orders generated for the specified date range, with purchase orders listed by the date Procure+generated a purchase order. The name of the user's organization, report title, and selected date range appear at the top of the report. The purchase order information listed in the report includes the requisition number, shopper, shopper department, purchase order number, purchase order date, purchase order amount, and status of each listed purchase order. The report also lists the total amount of the listed purchase orders.

REQUISITIONS BY DATE—enables a user to view the requisitions generated for the specified date range, with requisitions listed by the date a requisition was entered in into the procurement system database. The name of the user's organization, report title, and selected date range appear at the top of the report. The requisition information listed in the report includes the requisition number, shopper, shopper department, purchase order number, purchase order date, purchase order amount, and status of each listed requisition. The report also lists the total amount of the listed requisitions.

PURCHASE ORDERS BY STATUS—enables a user to view the purchase orders generated for a specified date range, with purchase orders listed by status-In Process, Deleted, At Seller, Cancelled, Processed by Seller, Back Ordered, Shipped, Received, and Discontinued. The name of the user's organization, report title, and selected date range appear at the top of the report. The purchase order information listed in the report includes the requisition number, shopper, shopper department, purchase order number, purchase order date, purchase order amount, and status of the selected purchase orders of a status. The report also lists the total amount of the selected purchase orders of a status and the total amount of all listed purchase orders.

VOLUME BY VENDOR—enables a user to view the total amount of purchase orders sent to each vendor for a specified date range. The name of the user's organization, report title, and selected date range appear at the top of the report.

VOLUME BY MANUFACTURER—enables a user to view the total amount of products ordered from each manufacturer for the purchase orders created for a specified date range. The name of the user's organization, report title, and selected date range appear at the top of the report.

ANALYSIS OF TIME—enables a user to view the time required to route a requisition through its assigned workflow for the requisitions created for a specified date range. The name of the user's organization, report title, and selected date range appear at the top of the report.

### Producing a Report

In a preferred embodiment, an authorized user follows the same procedure for producing a report:

Select the type of report from the Report drop-down menu;

Enter the Start Date of the date range for which records are to be selected for the report;

Enter the End Date of the date range for which records are to be selected for the report; and

Select Retrieve to produce the report.

After the report appears it can be viewed, saved to a file using the Save As option, and printed.

Because many varying and different embodiments may be made within the scope of the inventive concepts herein taught, and because many modifications may be made in the embodiments herein detailed in accordance with the descriptive requirements of the law, it is to be understood that the details herein are to be interpreted as illustrative and not in a limiting sense. For example, in discussing Internet accessibility, this can be achieved in a variety of ways including wireless handheld devices, portable terminals, workstations, and any other devices or means which provides Internet access to the host for the system of the present invention. Further, the terms ‘product’ and 1 asset’ are used to represent an item being offered as a product for sale by a seller, and item purchased or leased and tracked as an asset by a procuring organization. Thus the terms 1; product’ and ‘asset’, as employed herein, represent the same item.

We claim:

1. A system for procuring assets, said system comprising:
a host system;
communication network means interfaced with said host system;
at least one remote site of at least one procuring organization, said remote site interfaced to said host system for data exchange via said communications network means;
at least one catalog of assets located at said host system, said assets of said at least one catalog available from at least one seller, said at least one catalog assigned at least to said at least one procuring organization;
wherein, said procuring organization accesses said at least one catalog at said host system from said at least one remote site via said communications net, selects matching assets from said at least one catalog according to search criteria and orders said selected assets from said at least one seller.

2. The system according to claim 1, wherein said remote site further comprises:
means for authorizing a plurality of approved shoppers of said procuring organization to have access to said at least one catalog at said host system;
means for said authorized plurality of approved shoppers to access and search said at least one catalog at said host system to identify a subset of said assets that match search criteria and to select assets therefrom;
means for said authorized plurality of approved shoppers to create at least one electronic order for said selected assets comprising a line item for each said selected asset;
means for routing said at least one electronic order through said procuring organization according to at least one approval business rule for setting approval status of each said line item;
means for, once approved, sending said approved at line item as at least one purchase order directly to said at least one seller of each said line item for fulfillment, and
means for tracking fulfillment status of said line item after sending said purchase to said at least one seller for fulfillment.

3. The system according to claim 2, wherein said host system further comprises:
means for authorizing a plurality of salespersons of at least one seller to create and store at least one catalog of assets available from said at least one seller to said plurality of authorized shoppers of said at least one procuring organization for selection of assets therefrom,
means for said at least one seller to accept said approved electronic order for assets selected from said at least one catalog of assets by said plurality of authorized shoppers; and
means for said at least one seller to provide fulfillment status of each said line item of said accepted electronic order to said at least one procuring organization.

4. The system according to claim 3, further comprising:
at least one procurement database within said host system for storing and maintaining information comprising:
i. said at least one catalog of assets,
ii. asset purchase order records corresponding to said line items of said at least one electronic order and the fulfillment status of each said line item,
iii. at least one approval business rule defining the approval workflow route in said at least one procuring organization for approval of procurement of assets from said at least one catalog by said plurality of approved shoppers,
iv. an organization structure of said at least one procuring organization having a hierarchy of at least one structural element, said at least one of said structural element having an associated at least one approval workflow route and an associated at least one of said plurality of approved shoppers wherein said at least one of said plurality of approved shoppers inherits said associated at least one approval workflow route of said structural element.

5. The system according to claim 4, wherein:
said host system is provided by a host organization; and
said at least one catalog of assets is provided by said host organization as the one seller.

6. The system according to claim 5, wherein said at least one catalog further comprises:
a standard catalog of assets each having a standard configuration of component assets, said component assets being approved by said procuring organization for purchase at a pre-negotiated price by said plurality of approved shoppers;
at least one blank worksheet for said plurality of approved shoppers to create said electronic order by directly entering asset information for at least one asset instead of searching for said at least one asset in said at least one catalog of assets;
at least one non-catalog worksheet for said plurality of approved shoppers to create said electronic order by directly entering asset information for at least one asset when said asset is not contained in said at least one catalog; and
at least one customized seller catalog having assets available from one seller, said assets being approved by said procuring organization for purchase at a pre-negotiated price by said plurality of approved shoppers; and
a full catalog of assets available from said host organization as the one seller of assets in the full catalog.

7. The system according to claim 4, wherein:
said approved at least one electronic order is stored as a named template for an electronic order in said at least one database; and
said system further comprises means for selecting said at least one named template for inclusion in said at least one electronic order.

8. The system according to claim 4, wherein said communications network means is the Internet.

9. The system according to claim 4, wherein said means for creating an electronic order is a shopping cart into which asset selections can be placed, accumulated, and removed by an approved shopper.

10. The system according to claim 4, further comprising:
means for providing search criteria for selecting at least one of said asset purchase order records stored in said database at said host system from at least said at least one remote site over said communications network;
means at said host system for selecting said asset purchase order records stored in said database that correspond to said search criteria;
means for outputting to at least said remote site over said communications network means said selected asset purchase order records;
means at least at said at least one remote site for displaying said output asset purchase order records.

11. The system according to claim 10, further comprising:
means for providing selection criteria for selecting at least one type of asset information stored in said database to said host system from at least said at least one remote site over said communications network;
means at said host system for selecting said asset information stored in said database that correspond to said selection criteria;
means for formatting as reports and outputting to at least said remote site over said communications network means said reports of asset information;
means at least at said at least one remote site for displaying said reports.

12. The system according to claim 11, wherein:
said at least one remote site further comprises at least one legacy system connected to said remote communication means;
said host system further comprises
i. means for storing said output asset purchase order records in files,
ii. means for storing said reports in files, and
iii. means for downloading said files from said host system to said at least one legacy system over said communication network means.

13. A method for procuring assets, said method comprising the steps of:
providing a host system;
providing access to said host system for at least one procurement organization;
maintaining a plurality of catalogs of assets at said host system, said assets of each of said plurality of catalogs being available from one seller;
assigning at least one of said plurality of catalogs to said at least one procurement organization by the one seller of said at least one of said plurality of catalogs;
providing search criteria to said host system by said at least one procurement organization;
selecting matching assets from said at least one assigned catalog by said at least one procurement organization according to the provided search criteria;
when at least one matching asset is selected, sending an electronic purchase order by said procurement organization for said at least one selected matching asset to a seller of that asset.

14. The method according to claim 13, further comprising the steps of:
defining at least one purchase order approval workflow by said at least one procurement organization;
prior to the step of sending said electronic purchase order, approving said electronic purchase order by said procurement organization according to at least said defined at least one purchase order approval workflow.

15. The method according to claim 13, wherein the step providing access to the host system further comprises the steps of:
providing communications network means connected to the host system;
creating at least one remote site for the at least one procurement organization; and
providing access from the at least one remote site to the host system over the communications network means for the host system and the at least one procurement organization to exchange data.

16. The method according to claim 13, wherein:
the step of providing a host system further comprises the step of:
providing said host system by a host organization; and
the maintaining step further comprises the step of
maintaining at least one catalog of assets available from said host organization as the one seller.
